(19) United States
(12) Patent Application Publication
(10) Pub. No.: US 2025/0381781 A1
(43) Pub. Date: Dec. 18, 2025

(54) INKJET CARTRIDGES

(71) Applicant: Sakura Finetek U.S.A., Inc., Torrance, CA (US)

(72) Inventors: Amit D. Shah, Redondo Beach, CA (US); Wen I Liu, Hsinchu City (TW); Yu Ming Chang, Hsinchu City (TW); ChenYu Cheng, Hsinchu City (TW)

(73) Assignee: Sakura Finetek U.S.A., Inc., Torrance, CA (US)

(21) Appl. No.: 18/741,662

(22) Filed: Jun. 12, 2024

(51) Int. Cl. B41J 2/175

(52) U.S. Cl. CPC B41J 2/17556; B41J 2/17513

(57) ABSTRACT

An inkjet cartridge comprising a reservoir operable to contain a solution and a pressure regulator disposed in the reservoir, the pressure regulator comprising a non-metallic material.

### FIELD

Inkjet cartridges

### BACKGROUND

Inkjet cartridges are generally a component of an inkjet printer that contains a solution for printing onto a substrate by spraying droplets of the solution onto the substrate in response to instructions from the inkjet printer. The solution may be, for example, an ink for printing on a substrate such as paper or a reagent for dispensing or printing onto a substrate for various analyzing or scientific applications. An inkjet cartridge contains one or more reservoirs of the solution connected to a printhead. Examples of inkjet cartridges include thermal inkjet cartridges and piezoelectric inkjet cartridges. Thermal inkjet cartridges generally contain a print head including an array of nozzles, a reservoir of a solution (e.g., ink, reagent) behind the nozzles, and a heating element including a metal plate or resistor adjacent the reservoir. In response to a signal from the inkjet printer, a current pulse flows through the heating element and vaporizes a small amount of solution in the reservoir and creates sufficient pressure for a drop of the solution to be ejected from the nozzle of the printhead. Piezoelectric inkjet cartridges generally use a piezoelectric crystal in a nozzle rather than a heating element. When current is applied, the crystal changes shape or size which increases the pressure in the inkjet cartridge solution channel and forces a droplet of solution from the nozzle. One parameter in both thermal inkjet cartridges and piezoelectric inkjet cartridges is the back pressure or reservoir pressure. The back pressure or reservoir pressure is below atmospheric pressure (negative).

### BRIEF DESCRIPTION OF THE DRAWINGS

FIG. 1A is a perspective view of an inkjet cartridge.

FIG. 1B is an exploded perspective view of the inkjet cartridge of FIG. 1A.

FIG. 2 is a sectional view of the inkjet cartridge of FIG. 1A through line 2-2′.

FIG. 3 is a cross-sectional view of the inkjet cartridge of FIG. 1A through line 3-3′ of FIG. 2.

FIG. 4 is schematic side view of the pressure regulator of the inkjet cartridge of FIG. 1A in a relaxed state.

FIG. 5 is a cross-sectional side view of the inkjet cartridge of FIG. 1A through line 3-3′ of FIG. 2 with a solution (e.g., ink, reagent) occupying a significant volume in the reservoir (e.g., a full reservoir).

FIG. 6 is a cross-sectional side view of the inkjet cartridge of FIG. 1A through line 3-3′ of FIG. 2 with a solution (e.g., ink, reagent) occupying an insignificant volume in the reservoir (e.g., an empty or near empty reservoir).

FIG. 7 is a graph of a force exerted on opposing walls of an inkjet cartridge by a metal bow or leaf spring including two rhombus-shaped strips for different spring heights or gaps.

FIG. 8 shows a graph of a force exerted on opposing walls of an inkjet cartridge by different bow or leaf springs including two rhombus-shaped strips of polyethylene terephthalate (PET) for different spring heights or gaps.

FIG. 9 shows a graph of the back pressure or negative pressure versus reservoir volume for pressure regulators of an inkjet cartridge using bow or leaf spring and three pressure regulators including two rhombus-shaped strips made of either metal or polyethylene terephthalate (PET).

FIG. 10A shows a graph of a force exerted on opposing walls of an inkjet cartridge by eight pressure regulators similar to pressure regulator 130 using a bow or leaf spring including two rhombus-shaped strips of polycarbonate (PC) or polypropylene (PP) of different thicknesses and opposing plates of similar material.

FIG. 10B shows a graph of a force exerted on opposing walls of an inkjet cartridge by eight pressure regulators similar to pressure regulator 130 using a bow or leaf spring including two rhombus-shaped strips of polypropylene (PP) or polyvinyl chloride (PVC) of different thicknesses and opposing plates of similar material.

FIG. 11A shows a graph of the back pressure or negative pressure for eight inkjet cartridges using pressure regulators similar to pressure regulator 130 using a bow or leaf spring including two rhombus-shaped strips of PC or PP and opposing plates of similar material; and

FIG. 11B shows a graph of the back pressure or negative pressure for eight inkjet cartridges using pressure regulators similar to pressure regulator 130 using a bow or leaf spring including two rhombus-shaped strips of PP or PVC and opposing plates of similar material.

### DETAILED DESCRIPTION

An inkjet cartridge is disclosed suitable for containing a solution (e.g., ink, reagent), mounting in an inkjet printer and dispensing the solution as directed by signals from the inkjet printer. The inkjet cartridge uses non-metallic material such as polymer(s) (e.g., plastic) for all components that might come into contact with a solution (e.g., ink, reagent) between the reservoir and the printhead. The non-metallic material may be selected to be inert to the solution (e.g., ink, reagent) in the reservoir of an inkjet cartridge so as not to alter or materially change the solution or degrade the components of the inkjet cartridge. The inkjet cartridge includes a casing defining an interior volume; a printhead coupled to a snout portion of the casing; a first wall and an opposing second wall defining a reservoir in the interior volume, the first wall and the second wall each made of a flexible, non-elastic and non-metallic material; a pressure regulator disposed in the reservoir, the pressure regulator comprising a spring, a first plate and a second plate each of which is comprised of non-metallic material, wherein the spring is coupled to a first side of the first plate and to a first side of the second plate such that the spring is disposed between the first plate and the second plate and a second side of the first plate is coupled to the first wall and a second side of the second plate is coupled to the second wall.

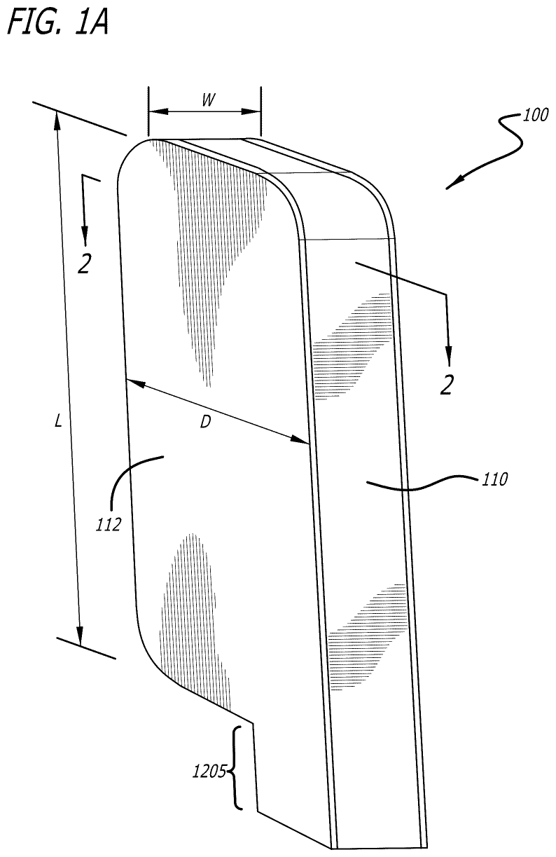

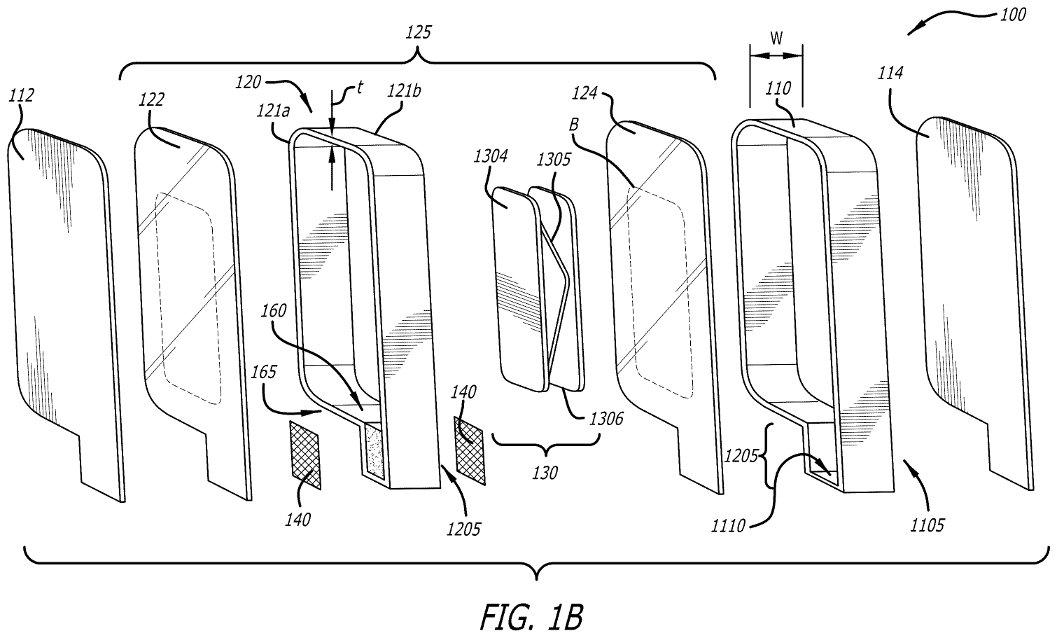

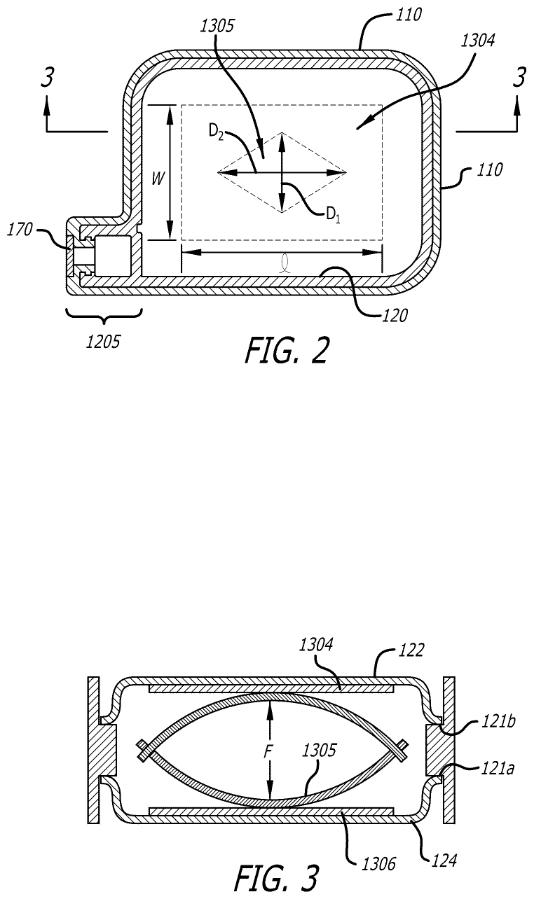

FIGS. 1A-3 show different views of an example of an inkjet cartridge. A thermal inkjet cartridge is described. It is appreciated that the use of non-metallic materials as described may be incorporated into a piezoelectric inkjet cartridge as well. Inkjet cartridge 100 includes a body defining an exterior of the cartridge, the body including, in this example, casing 110 having a generally rectangular perimeter (length, L and width, W) with downwardly protruding snout portion 1105 at one side of its base as viewed in FIG. 1A and FIG. 1B. Representative dimensions for casing 110 include, but are not limited to a length, L, of 2 centimeters (cm) to 8 cm, a depth, D, of 2 cm to 8 cm, and a width, W, of 1 cm to 3 cm. Casing 110 may take on any number of other shapes and dimensions such as shapes and dimensions to accommodate the desired volume of solution and/or the envelope of a printer/plotter housing, if inkjet cartridge 100 is enclosed within such a housing. A width, W, of casing 110 defines an interior volume of inkjet cartridge 100 and separates opposing housing sidewalls 112 and 114. Housing sidewalls 112 and 114 have a shape similar to casing 110 and may be affixed to casing 110 through an adhesive, heat bonding or press fittings. Sidewalls 112 and 114 may be made of a rigid polymer or plastic material similar to a material of casing 110 or may be a made of a material that is more flexible in the presence of atmospheric pressure. In another example, sidewalls 112 and 114 may not be present (i.e., the sidewalls are optional). Snout portion 1105 of inkjet cartridge 100 may be a portion of casing 110 and provides a route for the discharge of a solution within inkjet cartridge 100 and includes discharge opening 1105 in its lowermost end wall to which is affixed, on its exterior surface, inkjet printhead 170 (see FIG. 2). Casing 110 including snout portion 1105 may representatively be made of a rigid polymer or plastic material by a molding technique. Sidewalls 112 and 114, if present, may also representatively be made of a rigid polymer or plastic material by a molding technique.

Disposed within the body defined by casing 110 and sidewalls 112 and 114 is frame 120. Frame 120 has a shape similar to casing 110 and is formed to have an exterior perimeter that is smaller than an interior perimeter of casing 110 so that frame 120 may fit snuggly against each inner wall within casing 110. Frame 120 is made of a relatively rigid non-metallic material, such as a relatively rigid polymer or plastic. Examples of suitable polymers or plastic for frame 120 include, but are not limited to, a polyoxymethylene (POM), a high density polyethylene (HDPE), a polypropylene (PP), an acrylonitrile butadiene styrene (ABS), a polyvinyl chloride (PVC), a polyether ether ketone (PEEK), a polyphenylene sulfide (PPS) and a nylon. Frame 120 has a thickness suitable to provide surface area for the attachment of walls thereto to define reservoir in within the body of cartridge 100. A representative thickness, t, is on the order of a 0.5 to 5 millimeters (mm).

Connected to opposing sides 121a and 121b of frame 120 are respectively wall 122 and wall 124. Wall 122 and wall 124 may be connected to respective ones of side 121a and side 121b of frame 120 to form a continuous seal between the walls and frame 120 with an adhesive or by heat welding. Wall 122 and wall 124 together with an inside perimeter of frame 120 define a reservoir to store a solution such as an ink or reagent for dispensing from inkjet cartridge 100. Wall 122 and wall 124 are each made of a non-metallic material such as a polymer or plastic that is chemically inert to a solution (e.g., ink, reagent) that will be contained between the walls. A material of wall 122 and wall 124 may be a flexible material that is inelastic or resistant a return to its original shape spontaneously after contraction or distortion. Such a material will allow wall 122 and wall 124 to collapse inwardly as the volume of a solution in the reservoir declines. A suitable material includes, but is not limited to, a polyethylene (various densities), a polyethylene terephthalate (PET), a polyester, or a nylon having a thickness on the order of 1 mil to 3 mils. Another example of a suitable material of wall 122 and wall 124 is a foil (e.g., aluminum foil) coated with a chemically inert polymer on at least a side that will be in contact with a solution contained between the walls. Wall 122 and wall 124 may be connected to frame 120 at their periphery by an adhesive or heat welding. Opening 160 is formed in a base of frame 120 to provide a passage for a solution (e.g., ink, reagent) to be introduced into the reservoir. Opening 160 may be closed or plugged with stopper 165 of, for example, a polymer or plastic material such as PET, nylon, polyester or HDPE. An alternative to a reservoir assembly of frame 120, wall 122 and wall 124 that define a reservoir, the reservoir assembly may be a pouch or bag that is sized to fit within casing 110 and sidewalls 112 and 114 and has a property to contain a solution introduced therein. Such a pouch or bag may be a flexible material that is inelastic or resistant to return to its original shape spontaneously after contraction or distortion and chemically inert to a solution that will be contained in the reservoir. Representative materials include, but are not limited to, a polyethylene (various densities), a PET, a polyester, or a nylon having a thickness on the order of 0.25 mil to 3 mils or a foil (e.g., aluminum foil) coated with a chemically inert polymer on at least a side that will be in contact with a solution contained between the walls.

Referring to FIGS. 1A-3, positioned in the reservoir defined by wall 122, wall 124 and a portion of frame 120 is pressure regulator 130. Pressure regulator 130 includes spring 1305, first plate 1304 and second plate 1306 each of which is made of a non-metallic material such as a polymer or plastic that is inert to a solution that will be contained in the reservoir. A representative non-metallic material comprises a polymer material comprising a glass transition temperature between −120° C. and 180° C., such as but not limited to between 0° C. and 180° or such as 30° C. and 180° C. A representative material for the components of pressure regulator 130 (spring 1305, first plate 1304 and second plate 1306) include, but are not limited to, a high density polyethylene (HDPE), a polyethylene terephthalate (PET), a polycarbonate (PC), a polypropylene (PP), a nylon, a polyether ether ketone (PEEK), a polyphenylene sulfide (PPS) or a polyvinyl chloride (PVC) and a material for spring 1305 may be the same or different than a material of first plate 1304 and/or second plate 1306. Pressure regulator 130 may be centered in the reservoir. Spring 1305 is disposed between first plate 1304 and second plate 1306 and is configured or designed to transfer a force, F, generated by spring 1305 to each of first plate 1304 and second plate 1306 to urge the plates apart. Spring 1305 is representatively a bow spring or leaf spring including two rhombus-shaped strips of non-metallic material formed with an arc at or near their center and connected to one another (e.g., an opposing hook connection) at opposite ends of the same diagonal to collectively adopt a prolate spheroid shape. The rhombus may be defined by a first diagonal, D₁, and a second diagonal, D₂ (see FIG. 2). A representative length of the first diagonal, D₁, is 1 cm to 4 cm, such as 2 cm to 3 cm, and a representative length of the second diagonal, D₂, is 4 cm to 7 cm, such as 5 cm to 6 cm. First plate 1304 and second plate 1306 have a rectangular shape and are generally parallel to one another. A representative length, l, of first plate 1304 and second plate 1306 is 4 cm to 7 cm, such as 5 cm to 6.5 cm, and such as 5 cm to 6 cm, and a representative width, w, is 2 cm to 5 cm, such as 3 cm to 4.5 cm, and such as 3 cm to 4 cm. A representative thickness of first plate and second plate is 0.2 millimeters (mm) to 0.6 mm, such as 0.3 mm to 0.5 mm and such as 0.35 mm to 0.45 mm. Spring 1305 as a bow spring or leaf spring as described may be connected to a center point of each of first plate 1304 and second plate 1306 by, for example, an adhesive or thermal bond. An opposite side of each of first plate 1304 and second plate 1306 may be connected to respective ones of wall 122 and wall 124 by, for example, a thermal bond or an adhesive.

With regard to pressure regulator 130, each of spring 1305, plate 1304 and plate 1306 are made of a non-metallic material such as a polymer or plastic. Pressure regulator 130 must be able to generate a back or negative pressure in the reservoir by transferring a force generated by spring 1305 outward to each of plate 1304 and plate 1306 which in turn transfers the force to wall 122 and wall 124, respectively. The back or negative pressure selected is, in one example, between one inch of water (about 250 pascals) and 12 inches of water (about 3000 pascals) or, in another example, between one inch of water (about 250 pascals) and six inches of water (about 1500 pascals). In the cartridge example mentioned here, a back or negative pressure less than one inch of water presents a risk that a solution (e.g., ink, reagent) will leak out of the nozzles while a back or negative pressure greater than 12 inches of water decreases the dispensing (printing) quality. Such back pressure values or range may vary depending on the cartridge design, size of the reservoir tank, flexibility of the ink reservoir walls, nozzle diameter, size and power of the resister plate or piezo crystal mechanism, among the other factors of the cartridge design. It has been determined that with metal springs, a spring with a low spring rate and relatively high starting force achieves the desired back or negative pressure. A bow or leaf spring including two rhombus-shaped strips of formed with an arc at or near their center and connected to one another at opposite ends of the same diagonal to collectively adopt a prolate spheroid shape provides a relatively constant force generated by the spring as function of the curvature of the spring. The nonmetallic (e.g., plastic, polymer) pressure regulator 130 described herein mimics the spring properties of a metal spring.

As noted above, frame 120 has a shape similar to the shape of casing 110. That shape includes snout portion 1205 that is configured to be positioned in snout portion 1105 when frame 120 is placed in casing 110. Snout portion 1205 provides a route for the discharge of a solution within the reservoir of inkjet cartridge 100 and includes a discharge opening in its lowermost end wall aligned with the discharge opening in snout portion 1105. Disposed within snout portion 1205 may be at least one filter. FIG. 1 shows two filters 140 positioned on opposite sides of snout portion 1205. Each filter 140 may have any desired shape (e.g., rectangular, round) and may be disposed in a frame (e.g., a rectangular frame for a rectangularly-shaped filter) where the filter is configured to be attached to frame 120 such as by an adhesive or force or snap fit or thermal bond. Each filter 140 is positioned to be in fluid communication with a solution in the reservoir. This may be achieved by placing filters 140 in frame 120 and then attaching wall 122 and wall 124 to snout portion 1205 to enclose the filters (e.g., wall 122 and wall 124 each have a shape similar to a profile of frame 120 with snout portion 1205. A material for a filter is chemically inert relative to a solution intended for the reservoir. An example is a non-metallic filter material such as a nylon or a polyester. If a filter has a frame, a material for such frame is also chemically inert relative to a solution intended for the reservoir. Suitable materials include, but are not limited to, a POM. a HDPE, a PP, an ABS, a PVC, a nylon, a PEEK, a PPS or a copolymer.

A reservoir assembly may be formed by placing pressure regulator 130 and filters 140 in frame 120 and attaching wall 122 to first plate 1304 and wall 124 to second plate 1306. The reservoir assembly may then mounted or affixed in casing 110. Wall 112 and wall 114 may then be affixed to opposite sides of casing 110. The reservoir of ink cartridge 100 may then be filled with a solution (e.g., ink, reagent) by introducing the solution through opening 160 in frame 120. Once introduced, opening 160 may be closed or plugged with stopper 165. Inkjet cartridge 100 as described may be a single-use cartridge (i.e., use the contents of the cartridge and then discard) or a refillable cartridge.

Pressure regulator 130 in the reservoir of inkjet cartridge 100 introduces a spring force to the reservoir which changes pressure in response to a change in solution (e.g., ink, reagent) in the reservoir (a change in volume of solution present in the reservoir). The spring force provided by pressure regulator 130 maintains a sub-atmospheric or negative pressure to inhibit solution (e.g., ink, reagent) from leaking from inkjet cartridge 100. As a solution (e.g., ink, reagent) is withdrawn from the reservoir, wall 122 and wall 124 of the reservoir which are flexible and plate 1304 and plate 1306 of pressure regulator 130 will respectively move towards each other due to atmospheric pressure until spring 1305 is in a flat configuration or an essentially flat configuration with plates 1304 and 1306 coming close to contact with each other so that the reservoir is substantially completely emptied of solution.

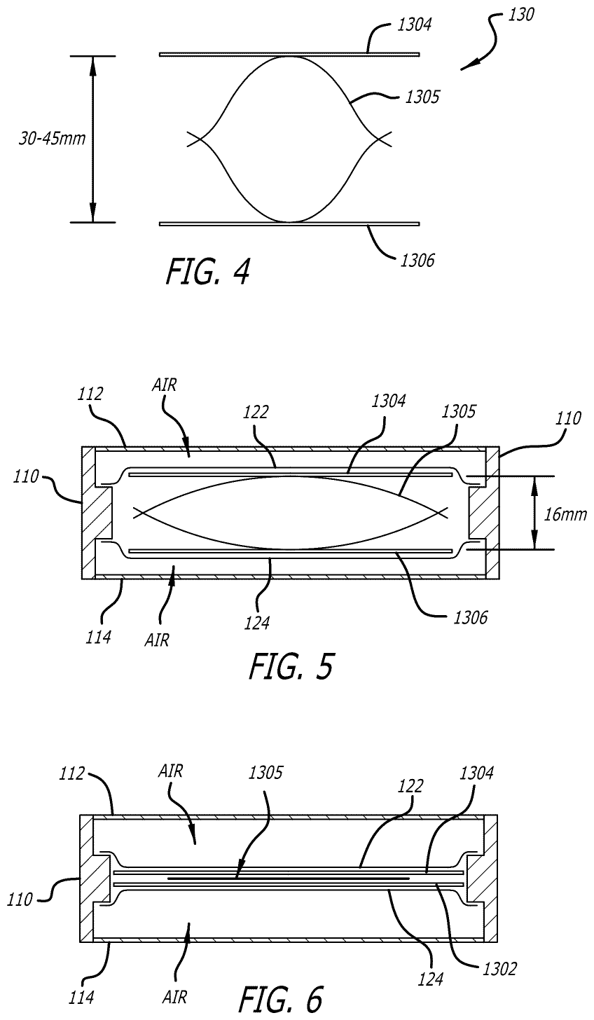

FIGS. 4-6 schematically illustrate an operation of pressure regulator FIG. 4 shows pressure regulator 130 in a relaxed state, for example, outside a reservoir. In this example, spring 1305 has a representative spring height of 30 mm to 45 mm, such as 30 mm to 40 mm and such as 30 mm to 35 mm measured as a distance between plate 1304 and plate 1306. FIGS. 5-6 show pressure regulator 130 in a reservoir of an inkjet cartridge and the change in a configuration of spring 1305 and walls 1304 and 1306 depending on a volume of a solution in the reservoir. In FIG. 5, there is a significant volume of solution (e.g., ink, reagent) in the reservoir (e.g., a full reservoir). Atmospheric pressure (air) on the outside of wall 122 and wall 124 (a side opposite the reservoir) resists an outward force of the solution in the reservoir and a spring force applied by spring 1305 on walls 1304 and 1306 so that, in this example, spring 1305 has a spring height of, for example, 16 mm. In FIG. 6, the volume of the solution (e.g., ink, reagent) in the reservoir is very low or empty. The atmospheric pressure (air) on the outside of wall 122 and wall 124 resists an outward pressure of spring 1305 to a point where a spring height of spring 1305 is near zero and wall 122 and wall 124 of pressure regulator 130 are almost in contact with one another.

As described above, exclusive of the printhead, all components of ink cartridge 100 that may be in contact with a solution therein (e.g., ink, reagent) are made of or coated with a non-metallic material. Such components include the reservoir assembly (frame 120, wall 112, wall 114), pressure regulator 130, filter(s) 140 and stopper 165. Ink cartridge 100 in this way provides a metal free path for a solution from the reservoir to the printhead. In addition to being non-metallic, a material for each of these components that is intended to be in contact with a solution in the reservoir may be selected to be chemically inert relative to the solution so that no reaction or degradation of the solution or the components occurs due to contact. A material for each of the reservoir assembly (frame 120, wall 112, wall 114), pressure regulator 130, filter(s) 140 and stopper 165 may be the same or different.

Table 1 shows results of a force exerted on opposing walls of a reservoir of an inkjet cartridge reservoir by six pressure regulators similar to pressure regulator 130 using a bow or leaf spring including two rhombus-shaped strips of metal and opposing plates of similar material. The bow or leaf spring and opposing plates are made of SUS 310, ¾ Hardness stainless steel. Each rhombus shaped strip of the spring has a thickness of 0.12 millimeters (mm), and a first diagonal of 4 cm and a second diagonal of 5 cm. Each of the opposing plates of the pressure regulator has a thickness of 0.18 mm, a length of 62.8 cm and a width of 31.5±1.5 cm. Table 1 shows the spring force at different spring heights (or gaps between plates) for each spring, 6 millimeters (mm), 10 mm and 16 mm.

TABLE 1
Spring Force of Metal Pressure Regulator

| | Force (Kg) | | |
|---|---|---|---|
| Gap (mm) | 6 | 10 | 16 |
| metal-05 | 0.34 | 0.39 | 0.41 |
| metal-06 | 0.34 | 0.38 | 0.41 |
| metal-07 | 0.34 | 0.38 | 0.40 |
| metal-08 | 0.36 | 0.40 | 0.43 |
| metal-09 | 0.37 | 0.42 | 0.44 |
| metal-10 | 0.35 | 0.39 | 0.42 |

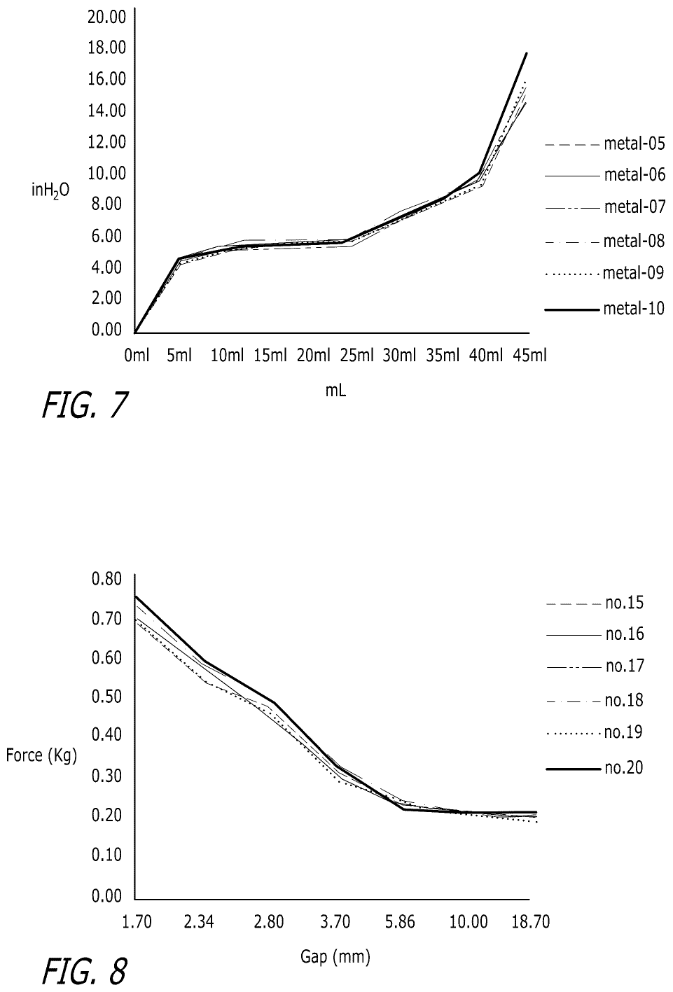

FIG. 7 shows a graphical representation of the back pressure or negative pressure for the pressure regulators in the six inkjet cartridges discussed with reference to Table 1. The 0 mL to 45 mL represents the air consumption (assumed equal to the ink consumption) in the cartridge. The “0 ml” represents a condition where the reservoir is full of air (simulating ink). Air is removed by a syringe at 5 mL intervals to measure a back pressure. The “inH20” is the back pressure measured by a pressure meter at each consumption level. The back pressures are graphed to show a pressure curve. Each of the cartridges saw a back pressure of between one inch of water and 18 inches of water as the volume in its respective reservoir increased from 0 milliliters to 45 milliliters. The results are also presented in Table 2.

TABLE 2
Cartridge Back Pressure Metal Pressure Regulator

| | (ml) | | | | | | | | | | |
|---|---|---|---|---|---|---|---|---|---|---|---|
| (inH2O) | 0 ml | 5 ml | 10 ml | 15 ml | 20 ml | 25 ml | 30 ml | 35 ml | 40 ml | 45 ml | 50 ml |
| metal-05 | 0.05 | 4.64 | 5.56 | 5.78 | 5.56 | 5.99 | 7.61 | 8.80 | 10.21 | 15.93 | 24.73 |
| metal-06 | 0.05 | 4.75 | 5.51 | 5.78 | 5.94 | 6.26 | 7.61 | 8.64 | 9.99 | 15.07 | 26.68 |
| metal-07 | 0.05 | 4.32 | 5.08 | 5.35 | 5.35 | 5.45 | 6.91 | 8.05 | 9.94 | 15.61 | 27.05 |
| metal-08 | 0.05 | 4.75 | 5.72 | 6.10 | 5.94 | 5.94 | 7.56 | 8.75 | 9.72 | 14.74 | 24.30 |
| metal-09 | 0.05 | 4.32 | 5.13 | 5.56 | 5.67 | 5.89 | 6.91 | 8.10 | 9.45 | 15.23 | 27.11 |
| metal-10 | 0.05 | 4.59 | 5.35 | 5.45 | 5.67 | 5.78 | 7.45 | 8.37 | 10.31 | 17.87 | 31.32 |

FIG. 8 shows a graph of a force exerted on opposing walls of a reservoir of six inkjet cartridges (No. 15-No. 20) by their respective pressure regulators similar to pressure regulator 130 using a bow or leaf spring including two rhombus-shaped strips of polyethylene terephthalate (PET) and opposing plates of similar material. The pressure regulator has a spring with each rhombus shaped strip having a first diagonal of 4 cm and a second diagonal of 5 cm. Each strip of the spring has a thickness of 0.4 mm. Each of the opposing plates of the pressure regulator has a thickness of 0.4 mm, a length of 6.2 cm and a width of 4.5 cm.

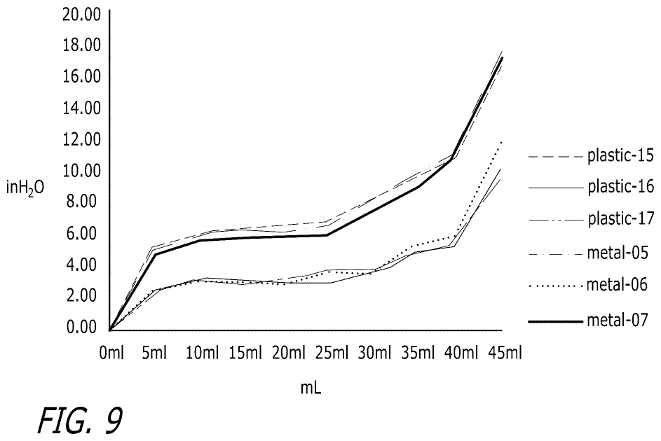

FIG. 9 shows a graph of the back pressure or negative pressure for three pressure regulators described with reference to FIG. 8 (Spring No. 15, Spring No. 16 and Spring No. 17) using a bow or leaf spring including two rhombus-shaped strips of polyethylene terephthalate (PET) and three pressure regulators described with reference to FIG. 7 and Table 1 and Table 2 (Spring No. 5, Spring No. 6 and Spring No. 7) using a metal bow or leaf spring including two rhombus-shaped strips. Similar to FIG. 7, the 0 mL to 45 mL represents the air consumption (assumed equal to the ink consumption) in the cartridge. FIG. 9 shows that the three pressure regulators similar to pressure regulator 130 using a bow or leaf spring including two rhombus-shaped strips of polyethylene terephthalate (PET) and opposing plates of similar material achieved a back pressure of between one inch of water and 12 inches of water over a reservoir volume range of 0 milliliters to 45 milliliters. The three metal pressure regulators similar to pressure regulator 130 achieved similar back pressure results.

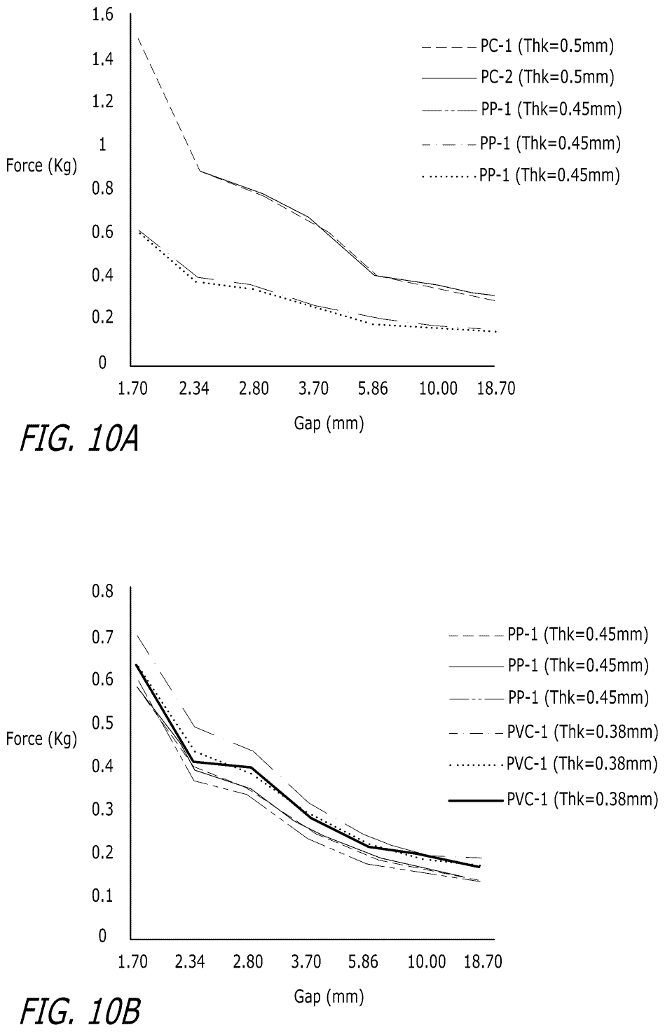

FIG. 10A shows a graph of a force exerted on opposing walls of an inkjet cartridge by five pressure regulators similar to pressure regulator 130 using a bow or leaf spring including two rhombus-shaped strips of polycarbonate (PC) or polypropylene (PP) and opposing plates of similar material with each strip and opposing plates having the dimensions specified in Table 3. FIG. 10A shows the spring force at different spring heights (or gaps between plates) for each spring. FIG. 10B shows a graph of a force exerted on opposing walls of an inkjet cartridge by eight pressure regulators similar to pressure regulator 130 using a bow or leaf spring including two rhombus-shaped strips of polypropylene (PP) or polyvinyl chloride (PVC) and opposing plates of similar material with each strip having the dimensions specified in Table 3. FIG. 10B shows the spring force at different spring heights (or gaps between plates) for each spring.

TABLE 3
Spring Force of PC, PP, and PVP Pressure Regulators

| | Force (Kg) | | | | | | |
|---|---|---|---|---|---|---|---|
| Gap (mm) | 1.70 | 2.34 | 2.80 | 3.70 | 5.86 | 10.00 | 18.70 |
| PC-1 (Thk = 0.5 mm) | 1.49 | 0.89 | 0.78 | 0.63 | 0.4 | 0.34 | 0.3 |
| PC-2 (Thk-0.5 mm) | | 0.9 | 0.79 | 0.63 | 0.4 | 0.35 | 0.3 |
| PP-1 (Thk = 0.45 mm) | 0.58 | 0.4 | 0.34 | 0.25 | 0.19 | 0.16 | 0.13 |
| PP-1 (Thk = 0.45 mm) | 0.6 | 0.39 | 0.34 | 0.25 | 0.19 | 0.16 | 0.13 |
| PP-1 (Thk = 0.45 mm) | 0.6 | 0.37 | 0.33 | 0.23 | 0.17 | 0.15 | 0.13 |
| PVC-1 (Thk = 0.38 | 0.7 | 0.49 | 0.43 | 0.31 | 0.23 | 0.19 | 0.18 |
| mm) | | | | | | | |
| PVC-1 (Thk = 0.38 | 0.63 | 0.43 | 0.38 | 0.29 | 0.22 | 0.18 | 0.16 |
| mm) | | | | | | | |
| PVC-1 (Thk = 0.38 | 0.63 | 0.41 | 0.39 | 0.28 | 0.21 | 0.19 | 0.16 |
| mm) | | | | | | | |

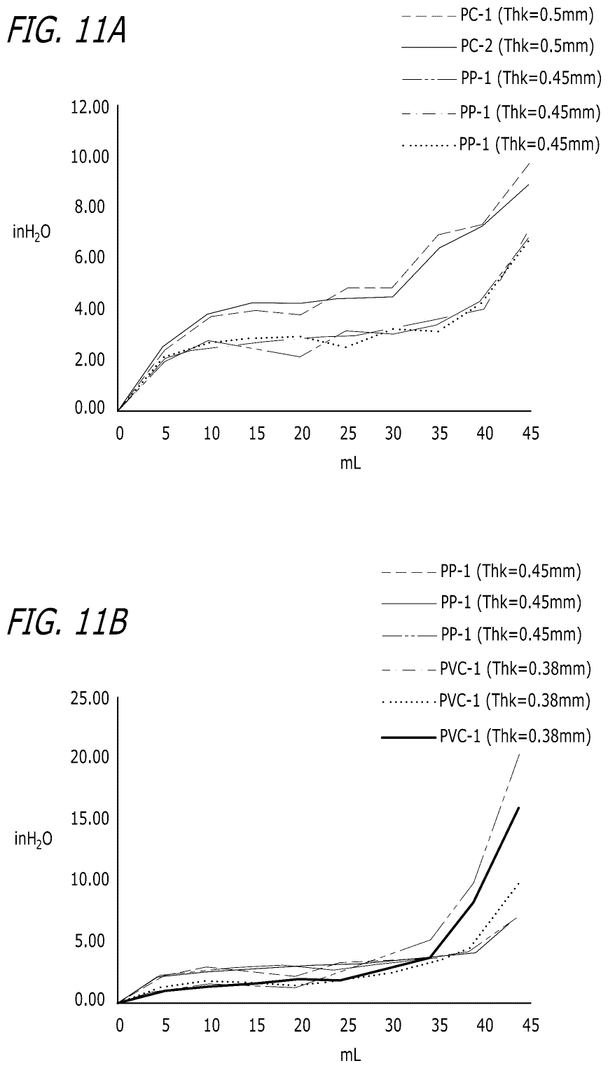

FIG. 11A and FIG. 11B show graphs of the back pressure or negative pressure for five inkjet cartridges described with reference to FIG. 10A and FIG. 10B. The results are set forth in Table 4. Each of the cartridges achieved a back pressure of between one inch of water and 12 inches of water over a reservoir volume range of 0 milliliters to 45 milliliters except two pressure regulators of PVC material which achieved back pressures of 15.82 inches of water and 20.09 inches of water at 45 milliliters of reservoir volume.

TABLE 4
Cartridge Back Pressure with PC, PP, or PVP Pressure Regulators

| | (ml) | | | | | | | | | |
|---|---|---|---|---|---|---|---|---|---|---|
| (inH2O) | 0 | 5 | 10 | 15 | 20 | 25 | 30 | 35 | 40 | 45 |
| PC-1 | 0.05 | 2.45 | 3.75 | 3.99 | 3.83 | 4.81 | 4.92 | 6.92 | 7.34 | 9.74 |
| PC-2 | 0.05 | 2.66 | 3.91 | 4.32 | 4.28 | 4.48 | 4.52 | 6.41 | 7.35 | 8.90 |
| PP-1 | 0.05 | 2.00 | 2.88 | 2.57 | 2.16 | 3.19 | 3.05 | 3.41 | 4.40 | 6.86 |
| PP-2 | 0.05 | 2.22 | 2.55 | 2.73 | 2.92 | 2.99 | 3.25 | 3.67 | 4.02 | 6.96 |
| PP-3 | 0.05 | 2.20 | 2.75 | 2.93 | 2.93 | 2.54 | 3.23 | 3.14 | 4.33 | 6.81 |
| PVC-1 | 0.05 | 0.97 | 1.46 | 1.50 | 1.21 | 2.14 | 3.16 | 5.00 | 9.88 | 20.09 |
| PVC-2 | 0.05 | 1.29 | 1.76 | 1.63 | 1.37 | 1.66 | 2.19 | 3.05 | 4.44 | 9.63 |
| PVC-3 | 0.05 | 0.97 | 1.27 | 1.47 | 1.86 | 1.70 | 2.67 | 3.62 | 8.06 | 15.82 |

In the above description a pressure regulator is described that includes a bow or leaf spring including two rhombus-shaped strips of polyethylene terephthalate (PET), polycarbonate (PC), polypropylene (PP) or polyvinyl chloride (PVC) and opposing plates of similar material. It is appreciated that other non-metallic materials, particularly polymers can be substituted. Representative examples of a material for the spring include a material that is inert to the solution to be contained in the reservoir of the inkjet cartridge, has an elastic modulus between 0.5 gigaPascals (GPa) and 8 GPa according to ASTM D638 or ISO 527-1:2012, and maintains a relatively constant spring force at different spring heights so that pressure regulator 130 may maintain a sub-atmospheric or negative pressure in an inkjet cartridge. It is also appreciated that while a bow or leaf spring is described as a portion of the pressure regulator, a shape/type of the non-metallic (e.g., polymeric) spring can vary. A suitable spring shape/type includes a spring that releases energy, ideally fairly consistent energy at different spring heights. Examples include compression springs. U.S. Pat. No. 5,325,119 describes a pressure regulator including a wire spring bent to a generally serpentine configuration for an inkjet cartridge. The pressure regulator has a variable spring function where the amount of force to collapse a regulator is fairly linear except the last few millimeters of travel requires less force than prior art designs. A non-metallic (e.g., polymer), inert plastic version of the pressure regulator with a serpentine spring and pressure regulators with similar variable spring function are also contemplated herein.

### ASPECTS

The following are aspects of the invention.

1. An inkjet cartridge comprising:
a reservoir operable to contain a solution; and
a pressure regulator disposed in the reservoir, the pressure regulator comprising a non-metallic material.

2. The inkjet cartridge of aspect 1, wherein the non-metallic material of the pressure regulator comprises a polymer material.

3. The inkjet cartridge of aspect 1 or 2, wherein the pressure regulator comprises a spring comprising a polymer material comprising a glass transition temperature between −120° C. and 180° C.

4. The inkjet cartridge of aspect 3, wherein the spring is a bow spring or a leaf spring.

5. The inkjet cartridge of aspect 3 or 4, wherein the pressure regulator comprises a first plate and a second plate, wherein the spring is coupled to a first side of the first plate and to a first side of the second plate such that the spring is disposed between the first plate and the second plate.

6. The inkjet cartridge of any of aspect 1-5, further comprising:
a casing defining an interior volume; and
a first wall and an opposing second wall defining the reservoir in the interior volume.

7. The inkjet cartridge of aspect 6, wherein the pressure regulator comprises a first plate and a second plate, wherein the spring is coupled to a first side of the first plate and to a first side of the second plate such that the spring is disposed between the first plate and the second plate and wherein a second side of the first plate is coupled to the first wall and a second side of the second plate is coupled to the second wall.

8. The inkjet cartridge of any of aspects 1-7, wherein the non-metallic material of the pressure regulator comprises a polyethylene terephthalate.

9. The inkjet cartridge of any of aspects 1-7, wherein the non-metallic material of the pressure regulator comprises a polycarbonate, a polypropylene or a polyvinyl chloride.

10. The inkjet cartridge of any of aspects 1-7, wherein the non-metallic material of the pressure regulator comprises a nylon, a high density polyethylene, a low density polyethylene or a polyester.

11. The inkjet cartridge of any of aspects 5-10, further comprising a frame coupled to an inner wall of the casing and conforming to the shape of a perimeter of the casing, wherein the first wall is coupled to a first side of the frame and the second wall is coupled to an opposite second side of the frame such that the frame, the first wall and the second wall define a volume of the reservoir.

12. The inkjet cartridge of aspect 11, further comprising at least one filter coupled to the frame inside the volume of the reservoir, wherein the at least one filter comprises a non-metallic material.

13. The inkjet cartridge of any of aspects 6-12, wherein the first wall and the second wall each comprise a flexible, non-elastic material and non-metallic material.

14. The inkjet cartridge of aspect 13, wherein the first wall and the second wall comprises a polymer that is chemically inert relative to a solution selected for containment in the reservoir.

15. The inkjet cartridge of aspect 14, wherein the polymer comprises a coating on the first wall and a coating on the second wall.

16. The inkjet cartridge of any of aspects 6-15, further comprising a stopper disposed between an exterior of the casing and the reservoir and the stopper comprises a non-metallic material.

17. The inkjet cartridge of any of aspects 1-16, further comprising a printhead in fluid communication with the reservoir.

18. An inkjet cartridge comprising:
a casing defining an interior volume;
a first wall and an opposing second wall defining a reservoir in the interior volume; and
a pressure regulator disposed in the reservoir, the pressure regulator comprising a spring comprising a non-metallic material.

19. The inkjet cartridge of aspect 18, wherein the pressure regulator further comprises a first plate and a second plate each of which is comprised of non-metallic material, wherein the spring is coupled to a first side of the first plate and to a first side of the second plate such that the spring is disposed between the first plate and the second plate.

20. The inkjet cartridge of aspect 18 or aspect 19, wherein the spring comprises a polymer material comprising a glass transition temperature between −120° C. and 180° C.

21. The inkjet cartridge of any of aspects 18-20, wherein the spring is a bow spring or a leaf spring.

22. The inkjet cartridge of any of aspects 18-21, further comprising a printhead in fluid communication with the reservoir.

Whereas specific aspects of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims and aspects appended and any and all equivalents thereof.

1. An inkjet cartridge comprising:
a reservoir operable to contain a solution; and
a pressure regulator disposed in the reservoir, the pressure regulator comprising a non-metallic material.

2. The inkjet cartridge of claim 1, wherein the non-metallic material of the pressure regulator comprises a polymer material.

3. The inkjet cartridge of claim 1, wherein the pressure regulator comprises a spring comprising a polymer material comprising a glass transition temperature between −120° C. and 180° C.

4. The inkjet cartridge of claim 3, wherein the spring is a bow spring or a leaf spring.

5. The inkjet cartridge of claim 3, wherein the pressure regulator comprises a first plate and a second plate, wherein the spring is coupled to a first side of the first plate and to a first side of the second plate such that the spring is disposed between the first plate and the second plate.

6. The inkjet cartridge of claim 1, further comprising:
a casing defining an interior volume; and
a first wall and an opposing second wall defining the reservoir in the interior volume.

7. The inkjet cartridge of claim 6, wherein the pressure regulator comprises a first plate and a second plate, wherein the spring is coupled to a first side of the first plate and to a first side of the second plate such that the spring is disposed between the first plate and the second plate and wherein a second side of the first plate is coupled to the first wall and a second side of the second plate is coupled to the second wall.

8. The inkjet cartridge of claim 1, wherein the non-metallic material of the pressure regulator comprises a polyethylene terephthalate.

9. The inkjet cartridge of claim 1, wherein the non-metallic material of the pressure regulator comprises a polycarbonate, a polypropylene or a polyvinyl chloride.

10. The inkjet cartridge of claim 1, wherein the non-metallic material of the pressure regulator comprises a nylon, a high density polyethylene, a low density polyethylene or a polyester.

11. The inkjet cartridge of claim 6, further comprising a frame coupled to an inner wall of the casing and conforming to a shape of a perimeter of the casing, wherein the first wall is coupled to a first side of the frame and the second wall is coupled to an opposite second side of the frame such that the frame, the first wall and the second wall define a volume of the reservoir.

12. The inkjet cartridge of claim 11, further comprising at least one filter coupled to the frame inside the volume of the reservoir, wherein the at least one filter comprises a non-metallic material.

13. The inkjet cartridge of claim 6, wherein the first wall and the second wall each comprise a flexible, non-elastic material and non-metallic material.

14. The inkjet cartridge of claim 13, wherein the first wall and the second wall comprises a polymer that is chemically inert relative to a solution selected for containment in the reservoir.

15. The inkjet cartridge of claim 14, wherein the polymer comprises a coating on the first wall and a coating on the second wall.

16. The inkjet cartridge of claim 6, further comprising a stopper disposed between an exterior of the casing and the reservoir and the stopper comprises a non-metallic material.

17. The inkjet cartridge of claim 1, further comprising a printhead in fluid communication with the reservoir.

18. An inkjet cartridge comprising:
a casing defining an interior volume;
a first wall and an opposing second wall defining a reservoir in the interior volume; and
a pressure regulator disposed in the reservoir, the pressure regulator comprising a spring comprising a non-metallic material.

19. The inkjet cartridge of claim 18, wherein the pressure regulator further comprises a first plate and a second plate each of which is comprised of non-metallic material, wherein the spring is coupled to a first side of the first plate and to a first side of the second plate such that the spring is disposed between the first plate and the second plate.

20. The inkjet cartridge of claim 17, wherein the spring comprises a polymer material comprising a glass transition temperature between −120° C. and 180° C.
